(19) United States
(12) Patent Application Publication
(10) Pub. No.: US 2006/0239564 A1
(43) Pub. Date: Oct. 26, 2006

(54) Device and method for generating JPEG file including voice and audio data and medium for storing the same

(75) Inventors: Hyuk Geun Cha, Seoul (KR); Ki Wook Yoon, Seoul (KR)

Correspondence Address: FOLEY AND LARDNER LLP;SUITE 500, 3000 K STREET NW, WASHINGTON, DC, 20007, US

(73) Assignee: Core Logic Inc.

(21) Appl. No.: 11/192,375

(22) Filed: Jul. 29, 2005

(30) Foreign Application Priority Data
Apr. 20, 2005 (KR) 10-2005-0032644

(51) Int. Cl. G06K 9/36; H04N 1/41; H04N 11/02

(52) U.S. Cl. 382/232; 358/426.01; 348/384.1

(57) ABSTRACT

A device and method for generating a Joint Picture Experts Group (JPEG) file is capable of effectively combining image data with voice/audio data using a JPEG file format, recording and storing the combined data, easily and reproducing the image data and the voice/audio data without separate synchronization information. The device includes a voice/audio encoder, a first buffer, a JPEG encoder and a JPEG packing unit. The voice/audio encoder encodes input voice/audio data and outputs encoded voice/audio data. The first buffer stores the encoded voice/audio data. The JPEG encoder encodes input image data into JPEG image data and outputs the JPEG image data. The JPEG packing unit outputs a single JPEG file by packing the encoded voice/audio data and the JPEG image data

### BACKGROUND OF THE INVENTION

1. Field of the Invention

The present invention relates generally to a device and method for generating a Joint Picture Experts Group file and a medium for storing the Joint Picture Experts Group file and, more particularly, to a device and method for generating a Joint Picture Experts Group file that includes voice and audio data and is capable of effectively combining, recording and displaying image data and voice/audio data in a digital still camera, and a medium for storing the Joint Picture Experts Group file.

2. Description of the Related Art

Generally, a digital still camera converts analog image signals, which are input through an image sensor, and analog voice/audio signals, which are acquired through a microphone, into digital signals. The digital signals are processed, and digital image and voice/audio data, which are generated as the result of signal processing, are stored in a frame memory. The stored digital image and voice/audio data are compressed, and the compressed digital image and voice/audio data are then stored on a storage medium, such as a memory card or a flash card.

In connection with such digital still cameras, conventional schemes have been proposed that record and store image data and also record voice/audio data (for example, voice/audio data having the Pulse Code Modulation (PCM), Qualcomm Code Excited Linear Prediction (QCELP), Adaptive Multi Rate (AMR), Enhanced Variable Rate Codec (EVRC), MPEG I Layer III (MP3) or Advanced Audio Coding (MC) recording format) corresponding to the image data in conjunction with the image data, and allow both the recorded image and voice/audio data to be reproduced in conjunction with each other. However, the conventional schemes are problematic in that the recording and reproduction of combined data are complicated, so that the efficiency or performance thereof is lowered, the synchronization of two types of data is difficult, and compatibility with a basic scheme is low.

### SUMMARY OF THE INVENTION

According to one aspect of the present invention, a device for generating a JPEG file includes a voice/audio encoder configured to encode input voice/audio data and to output the encoded voice/audio data, a first buffer that stores the encoded voice/audio data, a JPEG encoder configured to encode input image data into JPEG image data and to output the JPEG image data, and a JPEG packing unit configured to receive the encoded voice/audio data stored in the first buffer and the JPEG image data output from the JPEG encoder, and to output a single JPEG file by packing the encoded voice/audio data and the JPEG image data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a digital still camera system to which an embodiment of the present invention is applied;

FIG. 2 is a block diagram showing the construction of a device for generating a JPEG file according to the embodiment of the present invention;

FIG. 3 is a block diagram showing the construction of the JPEG encoder of FIG. 2 in detail;

FIG. 4 is a block diagram showing the construction of the JPEG decoder of FIG. 2 in detail;

FIG. 5 is a view showing the structure of the data packet of the JPEG file that has been stored in a medium for storing the JPEG file according to the embodiment of the present invention;

FIG. 6 is a flowchart showing the encoding process of a method of generating the JPEG file according to the embodiment of the present invention;

FIG. 7 is a flowchart showing the image data encoding step of FIG. 6 in detail;

FIG. 8 is a flowchart showing, in detail, the decoding process of the method of generating the JPEG file according to the embodiment of the present invention; and

FIG. 9 is a flowchart showing the image data decoding step of FIG. 8 in detail.

### DESCRIPTION OF THE PREFERRED EMBODIMENTS

The advantages and characteristics of the present invention, and a method of achieving them will be apparent with reference to the embodiment described in detail herein in conjunction with the accompanying drawings. The same reference numerals are used throughout the different drawings to designate the same or similar components.

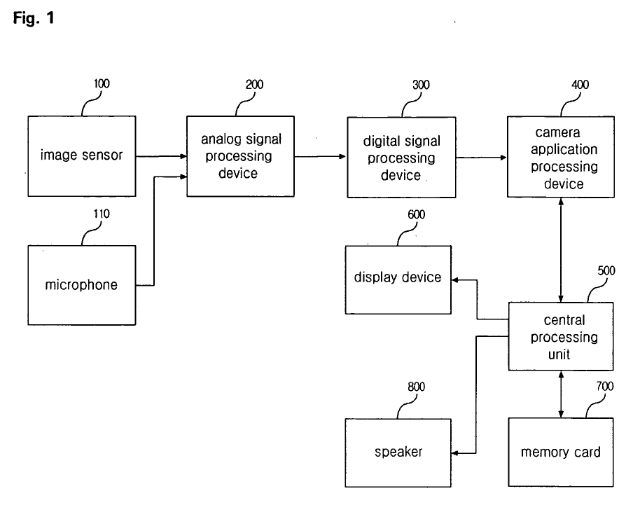

FIG. 1 is a block diagram showing the construction of the digital still camera system to which an embodiment of the present invention is applied. As shown in FIG. 1, the digital still camera system includes an image sensor 100, a microphone 110, an analog signal processing device 200, a digital signal processing device 300, a camera application processing device 400, a central processing unit 500, a display device 600, a memory card 700, and a speaker 800

The image sensor 100 is a device for photographing images using the light-sensitive characteristic of a semiconductor that detects the varying brightness and wavelength of light reflected from subjects and converts the detected brightness and wavelength into electrical values of corresponding pixels. The image sensor 100 converts the electrical values into a level at which signal processing can be performed.

That is, in general, the image sensor 100 is a semiconductor device for converting optical images into electrical signals. The image sensor 100 can be implemented as a Charge Coupled Device (CCD) image sensor in which individual Metal Oxide Semiconductor (MOS) capacitors are located closely adjacent to each other and charges are stored in the capacitors and transferred. Alternatively, the image sensor 100 can be implemented as a Complementary Metal Oxide Semiconductor (CMOS) image sensor that employs the CMOS technique using a control circuit and a signal processing circuit as peripheral circuits and adopts a switching method sequentially detecting outputs by forming and using MOS transistors in proportion to the number of pixels.

The CMOS image sensor has low power consumption, which makes it useful for a personal portable device, such as a mobile phone. Accordingly, the CMOS image sensor can be used in various applications, such as Personal Computer (PC) cameras, medical applications, and toy cameras.

In detail, the image sensor 100 preferably includes an optical imaging system having a lens, an iris, and an electronic shutter, and a CMOS imaging device. In the image sensor 100, when light from a subject is incident on the CMOS imaging device through the optical imaging system, photoelectrical conversion is performed by the CMOS imaging device to acquire analog image signals.

The CMOS imaging device is preferably formed with a plurality of pixels arranged in two-dimensional form, a vertical scanning circuit, a horizontal scanning circuit, and an image signal output circuit formed on a CMOS substrate. Each pixel preferably includes a photodiode, a transfer gate, a switching transistor, an amplification transistor, and a reset transistor. Such a CMOS imaging device can acquire Red, Green, and Blue (RGB) analog image signals or complementary color analog image signals.

The microphone 110 is a device that receives input sound signals, such as a user s voice and/or audio signals (voice/audio signals), and converts the received sound signals into electrical signals available for signal processing. Analog voice/audio signals can be acquired through the microphone 110.

The analog signal processing device 200 converts analog image signals, which are input from the CMOS imaging device included in the image sensor 100, and analog voice/audio signals, which are input through the microphone 110, into digital image and digital voice/audio signals, respectively, and transfers the converted image and voice/audio signals to the camera application processing device 400. In this case, the analog image and voice/audio signals are sampled and held, the gains of the analog image and voice/audio signals are controlled by auto gain control, and then the analog image and voice/audio signals are converted into digital image and voice/audio signals, respectively.

The digital image signals output from the analog signal processing device 200 are converted by the digital signal processing unit 300 into image data that includes information about a luminance signal and red and blue chrominance signals. The digital signal processing unit 300 also adjusts gain, white balance, gradation, and exposure values appropriate for various light sources.

Furthermore, the digital voice/audio signals output from the analog signal processing device 200 are converted by the digital signal processing unit 300 into voice/audio data that includes information about the frequency spectrum, intensity and waveform of the digital voice/audio signal.

The image data and the voice/audio data output from the digital signal processing device 300 are combined into a single JPEG file by the camera application processing device 400, and the single JPEG file is stored in the memory card 700 under the control of the central processing unit 500. In this case, the single JPEG file acquired by integrally storing the image data and the voice/audio data maintains the same format as an existing JPEG file so that intercompatibility can be provided.

Thereafter, the central processing unit 500 controls the camera application processing device 400 to separate the image data and the voice/audio data stored as a single JPEG file, thus allowing the image data to be displayed through the display device 600 and allowing the voice/audio data to be output through the speaker 800.

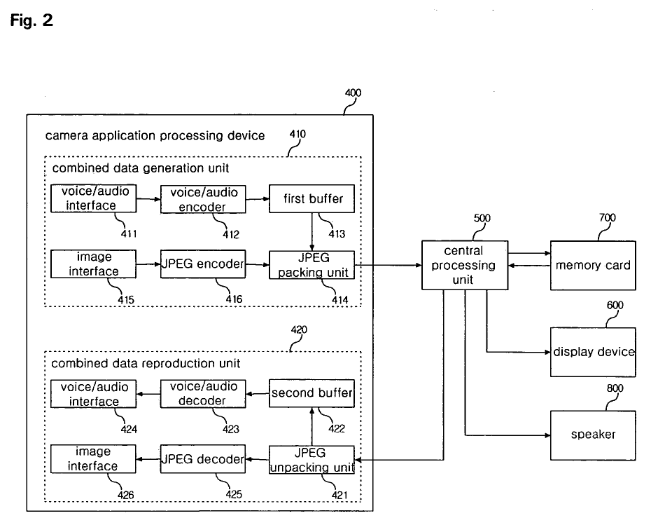

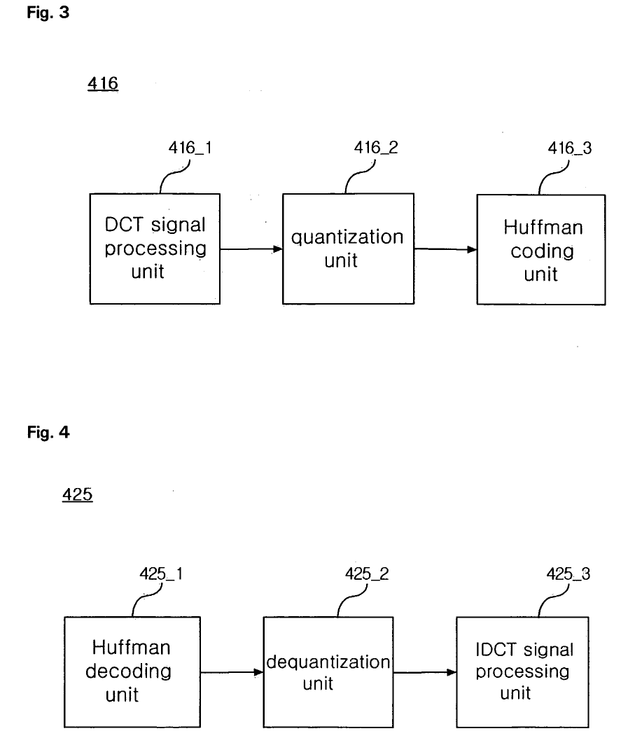

With reference to FIGS. 2 to 4, a device for generating a JPEG file according to an embodiment of the present invention is described in detail below. FIG. 2 is a block diagram showing the construction of the device for generating a JPEG file according to the embodiment of the present invention. FIG. 3 is a block diagram showing the construction of the JPEG encoder of FIG. 2 in detail. FIG. 4 is a block diagram showing the construction of the JPEG decoder of FIG. 2 in detail.

Referring to FIG. 2, the device for generating a JPEG file according to the embodiment of the present invention includes a combined data generation unit 410 for combining image data with voice/audio data into a single JPEG file, and a combined data reproduction unit 420 for separating the JPEG file into image data and voice/audio data and reproducing the separated data.

The combined data generation unit 410 includes a voice/audio interface 411, a voice/audio encoder 412, a first buffer 413, a JPEG packing unit 414, an image interface 415, and a JPEG encoder 416.

The voice/audio encoder 412 encodes the voice/audio data input from the digital signal processing device 300 through the voice/audio interface 411, outputs encoded voice/audio data and, as a result, the outputted encoded voice/audio data are stored in the first buffer 413. In this case, the encoded voice/audio data can be encoded in the PCM, QCELP, AMR, EVRC, MP3 or AAC recording format.

The JPEG encoder 416 encodes the image data input from the digital signal processing device 300 via the image interface 415 into JPEG image data and outputs the JPEG image data.

In detail, the JPEG encoder 416, as shown in FIG. 3, includes a Discrete Cosine Transform (DCT) signal processing unit 461_1, a quantization unit 416_2 and a Huffman coding unit 416_3. The DCT signal processing unit 461_1 reads image data of a predetermined size (for example, 8*8) block and performs DCT signal processing on the read data. The quantization unit 416_2 quantizes the DCT signal processed data, and the Huffman coding unit 416_3 performs Huffman coding on the quantized data. The Huffman-coded, separate block data are combined into JPEG image data, and the JPEG image data are transferred to the JPEG packing unit 414.

The JPEG packing unit 414 receives the encoded voice/audio data, which are stored in the first buffer 413, and the JPEG image data, which are output from the JPEG encoder 416, and outputs a single JPEG file by packing the encoded voice/audio data and the JPEG image data.

The single JPEG file, in which the image data and the voice/audio data are combined, is output from the JPEG packing unit 414 and transferred to the central processing unit 500. The central processing unit 500 performs control such that the outputted single JPEG file is stored in the memory card 700. By doing so, the encoded voice/audio data and the JPEG image data are packed in the memory card 700, so that the single JPEG file output as a single file is stored in the memory card 700. In this case, it is preferred that the memory card 700 be implemented using non-volatile memory so that the stored single JPEG file is not damaged.

In summary, the analog image signals and the voice/audio signals are acquired through the microphone 110 and the image sensor 100 and pass through the analog signal processing device 200 and the digital signal processing device 300 to generate digital voice/audio and image data. The voice/audio data and the image data are combined into a single JPEG file by the camera application processing device 400 and are then stored. The stored data are reproduced through the combined data reproduction unit 420.

In detail, the analog voice/audio signals input to the microphone 110 are digitized through the analog signal processing device 200 and the digital signal processing device 300. The camera application processing device 400 encodes the digitized voice/audio data into encoded voice/audio data, and stores the encoded voice/audio data in the first buffer 413 as continuous frames.

Furthermore, the analog image signals acquired by the image sensor 100 are digitized into image data, and are encoded into JPEG image data by the camera application processing device 400. When image data are encoded and JPEG image data corresponding to a single frame are produced, the JPEG image data are combined with the encoded voice/audio data retrieved from the first buffer 413 and are stored to generate a single JPEG file acquired by combining the encoded voice/audio data with the JPEG image data.

In this case, the voice/audio encoder 412 and the JPEG encoder 416 operate independently. The single JPEG file is generated by inserting the encoded voice/audio data at the time when the JPEG image data are produced.

The combined data reproduction unit 420 includes a voice/audio interface 424, a voice/audio decoder 423, a second buffer 422, a JPEG unpacking unit 421, a JPEG decoder 425 and an image interface 426.

The JPEG unpacking unit 421 receives the JPEG file, and separates the received JPEG file into the encoded voice/audio data and the JPEG image data by unpacking it.

The separated encoded voice/audio data are temporarily stored in the second buffer 422.

The voice/audio decoder 423 retrieves the encoded voice/audio data from the second buffer 422, decodes them, and outputs voice/audio data. The JPEG decoder 425 generates image data by decoding the JPEG image data, and outputs the generated image data through the image interface 426.

In detail, the JPEG decoder 425, as shown in FIG. 4, includes a Huffman decoding unit 425_1, a dequantization unit 425_2, and an Inverse Discrete Cosine Transform (IDCT) signal processing unit 425_3. The Huffman decoding unit 425_1 performs Huffman coding on the JPEG image data using a Huffman decoding table. The inverse quantization unit 425_2 performs dequantizaton on the decoded data. The IDCT signal processing unit 425_3 performs IDCT signal processing on the dequantized data IDCT to restore the image data.

The voice/audio data, which are output through the voice/audio interface 424, and the image data, which are output through the image interface 426, are transferred to the central processing unit 500, and the central processing unit 500 performs control such that the transferred voice/audio and image data are output through the speaker 800 and the display device 600, respectively.

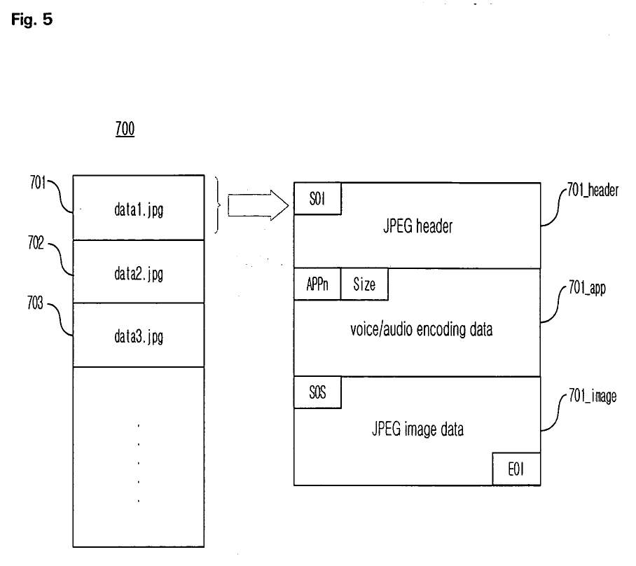

FIG. 5 is a view showing the structure of the data packet of the JPEG file that has been stored in a medium for storing the JPEG file according to the embodiment of the present invention.

In the medium of storing the JPEG file according to the embodiment of the present invention, JPEG image data and encoded voice/audio data are stored as a single JPEG file data1.jpg, data2.jpg or data3.jpg. In detail, as shown in FIG. 5, a plurality of JPEG files data1.jpg, data2.jpg and data3.jpg can be stored in different respective memory addresses 701 to 703 in the memory card 700. In each JPEG image file, the encoded voice/audio data are preferably inserted into the other application segment region 701_app of the JPEG image file, although the encoded voice/audio data can be inserted into other regions of the JPEG image file.

The data packet structure of the JPEG file data1.jpg includes a header region 701_header, an other application segment region 701_app, and an image region 701_image. The header region 701_header of the JPEG file data1.jpg stores data regarding the size of the JPEG file, a DCT signal processing method, a quantization method, and a Huffman coding method applied by the JPEG encoding process. The encoded voice/audio data are stored in the other application segment region 701_app, and the JPEG image data are stored in the image region 701_image.

In this manner, the JPEG file format is maintained and can be compatible with a conventional JPEG file format. In addition, the JPEG image data and the encoded voice/audio data can be integrally recorded and reproduced.

The JPEG file format has a form shown in FIG. 5, and, for example, may be set as Table 1.

TABLE 1

| Marker Name | Marker Identifier | Description |
|---|---|---|
| SOI | OxD8 | Start of Image |
| APPn | OxE1˜OxEF | Other APP Segment |
| SOS | OxDA | Start of Scan |
| EOI | OxD9 | End of Image |

With reference to Table 1 and FIG. 5, an example of the JPEG file format for storing both encoded voice/audio data and JPEG image data is described below.

As described above, the JPEG file format is divided into the header region 701_header, the other application segment region 701_app, and the image region 701_image.

The header region 701_header starts with 0XD8 indicating Start of Image (SOI), which is a marker name. This region stores data regarding the size of the JPEG file, a DCT signal processing method, a quantization method, and a Huffman coding method applied by the JPEG encoding process.

The other application segment region 701_app stores the encoded voice/audio data along with 0xE1˜0xEF indicating APPn (APP Segments), which is a marker name, and 2-byte size information.

The image region 701_image stores the image data. This region starts with 0xDA indicating Start of Scan (SOS), which is a marker name, and ends with 0xD9 indicating End of Image (EOI).

It is preferable to use a method of storing encoded voice/audio data in the other application segment region 701_app existing in the JPEG file format, rather than storing a separate file, as the method of combining the JPEG image data with the encoded voice/audio data.

The number of frames of the stored encoded voice/audio data varies and is determined depending on the time when the JPEG image data are produced. That is, the encoding of the voice/audio data is continuously performed while the image data are encoded into the JPEG image data, and the generation of the encoded voice/audio data is completed at the time when the JPEG image data are generated. For example, voice/audio data corresponding to N+1th JPEG image data are continuously encoded during a period from the time when the generation of arbitrary Nth JPEG image data is completed to the time when the generation of N+1th JPEG image data is completed, and are stored as a single JPEG file along with the N+1th JPEG image data.

In the JPEG file format, the other application segment region 701_app does not influence the decoding of the JPEG file at all. As a result, the JPEG image data separated from the JPEG file through the JPEG decoder 425 can be reproduced without an additional function and are completely compatible with the conventional JPEG file format.

In addition, the JPEG file, in which the encoded voice/audio data and the JPEG image data are integrally stored, allows the encoded voice/audio data to be stored in the second buffer 422 corresponding to the memory region of the voice/audio decoder 423 at the time when the JPEG image data are reproduced.

The voice/audio decoder 423 decodes the encoded voice/audio data stored in the second buffer 422 and outputs decoded voice/audio data through the voice/audio interface 424. The JPEG decoder 425 and the voice/audio decoder 423 operate independently, and the encoded voice/audio data stored in the second buffer 422 are decoded and reproduced at the time when the JPEG image data are reproduced.

All encoded voice/audio data that have been encoded up to the time when the single JPEG file was produced are temporarily stored in the first buffer 413 and are inserted in the JPEG image file at the time when the JPEG image data are generated to generate a single JPEG file. All encoded voice/audio data that have been extracted from the single JPEG file are temporarily stored in the second buffer 422 and are decoded at the time when the JPEG image data are displayed. Accordingly, reproduction can be performed without separate synchronization information. That is, the JPEG image data and the encoded voice/audio data corresponding to the JPEG image data are integrally stored in a single JPEG file, and the stored encoded voice/audio data are decoded and reproduced when the JPEG image data are reproduced. In this manner, it is possible to minimize the overhead generated when voice data are added.

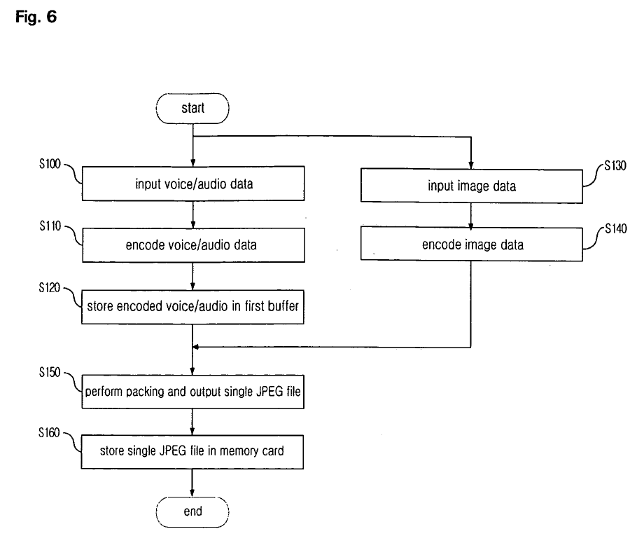

With reference to FIGS. 6 to 9, a method of generating a JPEG file according to the embodiment of the present invention is described in detail.

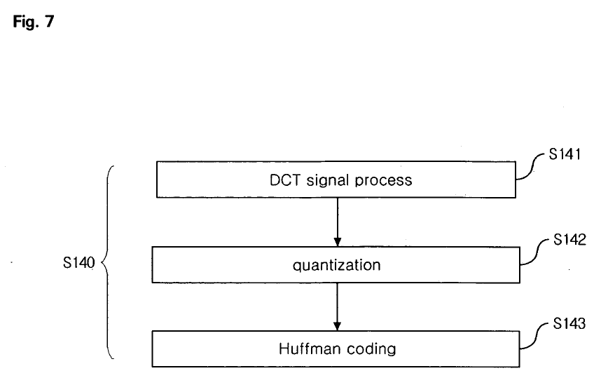

FIG. 6 is a flowchart showing the encoding process of the method of generating a JPEG file according to the embodiment of the present invention. FIG. 7 is a flowchart showing the image data encoding step of FIG. 6 in detail.

First, voice/audio data are input to the voice/audio encoder 412 through the voice/audio interface 411 at step S100.

The voice/audio encoder 412 encodes the input voice/audio data and outputs encoded voice/audio data at step S110. The outputted encoded voice/audio data are stored in the first buffer 413 at step S120.

Image data are input to the JPEG encoder 416 through the image interface 415 at step S130. The JPEG encoder 416 encodes the input image data into JPEG image data and outputs the JPEG image data at step S140.

In detail, the step S140 of encoding image data, as shown in FIG. 7, includes the DCT signal processing unit 461_1 reading image data of a predetermined size (for example, 8*8) block and performing DCT signal processing on the read data at step S141, the quantization unit 416_2 quantizing the DCT signal processed data at step S142, and the Huffman coding unit 416_3 performing Huffman coding on the quantized data at step S143. The Huffman-coded, separate block data are combined together to generate and output the JPEG image data.

The JPEG packing unit 414 outputs a single JPEG file by packing the encoded voice/audio data and the JPEG image data at step S150. In this case, it is preferred that the encoded voice/audio data are inserted into the other application segment region of the JPEG image data to output the encoded voice/audio data and the JPEG image data as a single JPEG file.

The output JPEG file is recorded and stored in the memory card 700 by the central processing unit at step S160.

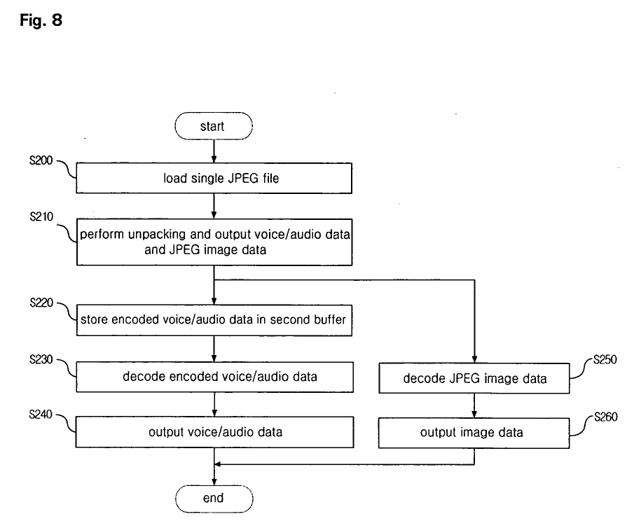

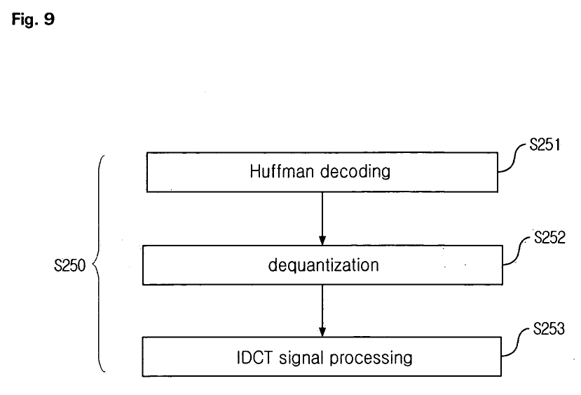

FIG. 8 is a flowchart showing, in detail, the decoding process of the method of generating a JPEG file according to the embodiment of the present invention. FIG. 9 is a flowchart showing the image data decoding step of FIG. 8 in detail.

First, the JPEG unpacking unit 421 receives the JPEG file from the memory card 700 through the central processing unit 500 at step S200.

The JPEG unpacking unit 421 separates the received JPEG file into encoded voice/audio data and JPEG image data by unpacking it at step S210. The JPEG image data are output to the JPEC decoder 425, and the encoded voice/audio data are stored in the second buffer 422 at step S220.

The voice/audio decoder 423 decodes the encoded voice/audio data at step S230, and outputs decoded voice/audio data through the voice/audio interface 424 at step S240.

The JPEG decoder 425 decodes the JPEG image data at step S250, and outputs decoded image data through the image interface 426 at step S260.

In detail, the step S230 of decoding image data, as shown in FIG. 9, includes performing Huffman decoding on the JPEG image data using a Huffman decoding table at step S251, dequantizing the decoded data at step S252, and restoring the image data by performing IDCT signal processing on the dequantized data at step S253.

Although the embodiment of the present invention has been described with reference to accompanying drawings, those skilled in the art can appreciate that the present invention may be implemented in some other concrete forms without departing from the technical sprit of the present invention or modifying the essential features of the present invention. Accordingly, since the above-described embodiment is provided to fully notify those skilled in the art of the scope of the present invention, it must be appreciated that the embodiment is illustrative in all aspects, but not restrictive. The present invention is defined only by the appended claims.

As described above, the device and method for generating a JPEG file and the medium for storing the JPEG file according to the embodiment of the present invention are capable of combining image data and voice/audio data using a JPEG file format, effectively recording and storing the combined data, easily reproducing the image data and the voice/audio data without separate synchronization information, and providing intercompatibility.

What is claimed is:

1. A device for generating a Joint Picture Experts Group (JPEG) file, comprising:
a voice/audio encoder configured to encode input voice/audio data and to output the encoded voice/audio data;
a first buffer that stores the encoded voice/audio data;
a JPEG encoder configured to encode input image data into JPEG image data and to output the JPEG image data; and
a JPEG packing unit configured to receive the encoded voice/audio data stored in the first buffer and the JPEG image data output from the JPEG encoder, and to output a single JPEG file by packing the encoded voice/audio data and the JPEG image data into the single JPEG file.

2. The device as set forth in claim 1, further comprising:
a JPEG unpacking unit configured to receive the JPEG file and to separate the received JPEG file into the encoded voice/audio data and the JPEG image data by unpacking the received JPEG file;
a second buffer that stores the encoded voice/audio data;
a voice/audio decoder configured to decode the encoded voice/audio data and to output the decoded voice/audio data; and
a JPEG decoder configured to decode the JPEG image data and to output the decoded image data.

3. The device as set forth in claim 1, wherein the JPEG packing unit is further configured to output the encoded voice/audio data and the JPEG image data as a single JPEG file by inserting the encoded voice/audio data and the JPEG image data into respective regions of the single JPEG file.

4. The device as set forth in claim 1, further comprising a memory card for storing the outputted single JPEG file.

5. A method of generating a JPEG file, comprising the steps of:
encoding input voice/audio data and outputting the encoded voice/audio data;
storing the encoded voice/audio data in a first buffer;
encoding input image data into JEPG image data and outputting the JPEG image data; and
outputting a single JPEG file by packing the encoded voice/audio data and the JPEG image data into the single JPEG file.

6. The method as set forth in claim 5, further comprising the steps of:
receiving the JPEG file and separating the received JPEG file into the encoded voice/audio data and the JPEG image data by unpacking the received JPEG file;
storing the encoded voice/audio data in a second buffer;
decoding the encoded voice/audio data and outputting the decoded voice/audio data; and
decoding the JPEG image data and outputting the decoded image data.

7. The method as set forth in claim 5, wherein, in the step of outputting the single JPEG file, the encoded voice/audio data and the JPEG image data are inserted into respective regions of the single JPEG file.

8. The method as set forth in claim 5, further comprising a step of storing the outputted single JPEG file in a memory card.

9. A medium for storing a JPEG file, the medium storing JPEG image data and voice/audio data as a single JPEG file.

10. The medium as set forth in claim 9, wherein the encoded voice/audio data and the JPEG image data are inserted into respective regions of the single JPEG file.
